(19) United States
(12) Patent Application Publication
(10) Pub. No.: US 2025/0359678 A1
(43) Pub. Date: Nov. 27, 2025

(54) CHAIR WITH CONNECTOR FOR ATTACHING BASE TO SEAT

(71) Applicant: AMTAB MANUFACTURING CORPORATION, Bensenville, IL (US)

(72) Inventors: Doss SAMIKKANNU, Bensenville, IL (US); Jeremias C. RIVERA, Jr., Bensenville, IL (US); Bin LIU, Bensenville, IL (US)

(21) Appl. No.: 18/670,495

(22) Filed: May 21, 2024

(51) Int. Cl. A47C 7/00; F16B 12/10

(52) U.S. Cl. CPC A47C 7/002; F16B 12/10; F16B 2012/106

(57) ABSTRACT

A chair includes a seat and a base attached to the seat. A connector is configured to secure the seat to the base. The seat is configured to support a user sitting on the chair, and the base is configured to support the seat relative to a surface beneath the chair. The connector includes a channel formed in the seat for receiving a cross-member of the base, a retention cover configured to extend into the channel to engage with the cross-member, and a plurality of fasteners configured to couple the retention cover with the seat to hold the cross-member in the channel.

### FIELD OF THE DISCLOSURE

The present disclosure relates to a chair, and particularly to a chair including a seat and a base attached to the seat. More particularly, the present disclosure relates to a chair including a connector for attaching the base to the seat.

### BACKGROUND

Chairs often incorporate a variety of materials, such as wood, plastic, and metal, making a strong, secure connection between the components difficult. Use of the chairs may subject the connectors, such as fasteners, to forces tending to pull them away from weaker materials, such as plastic. It would be desirable to have a chair with an improved connection to distribute forces placed on the chair.

This background information is merely for context and no admission is intended, nor should such admission be inferred or construed, that any of the preceding information constitutes prior art against the present disclosure.

### SUMMARY

According to an aspect of the present disclosure, a chair includes a seat and a base attached to the seat. A connector is configured to secure the seat to the base. The seat is configured to support a user sitting on the chair, and the base is configured to support the seat relative to a surface beneath the chair.

In illustrative embodiments, the connector includes a channel formed in the seat for receiving a cross-member of the base, a retention cover configured to extend into the channel to engage with the cross-member, and a plurality of fasteners configured to couple the retention cover with the seat to hold the cross-member in the channel.

In illustrative embodiments, threaded inserts engage with the seat, and the fasteners engage with the threaded inserts to hold the retention cover relative to the seat.

In illustrative embodiments, the channel includes a first section and a second section arranged at an angle relative to the first section to define a V-shape of the channel.

In illustrative embodiments, the retention cover includes a body and a plurality of holes extending through the body to receive the plurality of fasteners. The body defines a first arm and a second arm arranged at an angle relative to the first arm to define a V-shape of the retention cover.

In illustrative embodiments, the cross-member of the base includes a first beam and a second beam arranged at an angle relative to the first beam to define a V-shape of the cross-member.

In illustrative embodiments, the seat includes a user-support portion and a seat-support portion coupled to the user-support portion to define an internal cavity of the seat between the user-support portion and seat-support portion. The seat-support portion defines the channel and a tack-off, the tack-off extending from the channel toward the user-support portion to engage with the user-support portion.

In illustrative embodiments, the channel and the cross-member of the base are arranged at an angle relative to the surface beneath the chair such that the channel and the cross-member are positioned closer to the surface as the channel and the cross-member extend in a direction from a front of the chair toward a rear of the chair.

In illustrative embodiments, the tack-off is arranged at an angle relative to the surface beneath the chair such that the tack-off extends further away from the surface as the tack-off extends in a direction from the rear of the chair toward the front of the chair.

In illustrative embodiments, the body of the retention cover defines a face extending along a first side of the body and a groove extending along an opposite second side of the body. The groove is configured to engage with the cross-member of the base. A distance between the face and the groove increases as the retention cover extends in a direction from the rear of the chair toward the front of the chair.

In illustrative embodiments, the channel is defined by a front surface and a spaced apart rear surface connected by a curved intermediate surface. The front and rear surfaces are angled with respect to one another such that a distance between the front and rear surfaces decreases as the front and rear surfaces extend toward the intermediate surface.

In illustrative embodiments, the retention cover defines a front wall and an opposite rear wall. The front and rear walls extend between the face and the groove. The front and rear walls are angled with respect to one another such that a distance between the front and rear walls decreases as the front and rear walls extend toward the groove.

In illustrative embodiments, at least a portion of the front surface of the channel is arranged between the cross-member of the base and the surface beneath the chair, and at least a portion of the groove and front wall of the retention cover is arranged between the front surface and the cross-member, along a line perpendicular to the surface.

Other aspects and advantages of the present disclosure will become apparent upon consideration of the following detailed description and the attached drawings wherein like numerals designate like structures throughout the specification.

### BRIEF DESCRIPTIONS OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 is an upper perspective view of an embodiment of a chair in accordance with the present disclosure showing that the chair includes a seat for supporting a user sitting on the chair and a base coupled to the seat for supporting the seat relative to a surface beneath the chair;

FIG. 2 is a lower perspective view of the chair of FIG. 1 showing the a connector of the chair for securing the seat to the base;

FIG. 3 is an exploded assembly view of one of the chair of FIG. 2 showing that the connector includes a channel formed in the seat for receiving a cross-member of the base, a retention cover configured to extend into the channel to engage with the cross-member, and a plurality of fasteners configured to couple the retention cover with the seat to hold the cross-member in the channel;

FIG. 4 is a lower perspective view of the retention cover of FIG. 3 showing that a body of the retention cover defines a face extending along a first side of the body and a groove extending along an opposite second side of the body, shown in FIG. 5, for engaging with the cross-member of the base and that a front wall and an opposite rear wall extend between the face and the groove;

FIG. 5 is an upper perspective view of the retention cover of FIG. 4 showing the groove;

FIG. 6 is a partial lower view of the chair of FIG. 2 tilted slightly rearward showing the retention cover arranged in the channel to at least partially cover the cross-member of the base, shown in FIG. 7, and that the retention cover is coupled to the seat with the fasteners to hold the cross-member in the channel;

FIG. 7 is a view similar to FIG. 6 with the retention cover removed to show the cross-member arranged in the channel, shown in FIG. 8;

FIG. 8 is a view similar to FIG. 7 with the base removed to show the channel and a tack-off extending from the channel into the seat;

FIG. 8A is an enlarged view of the tack-off of FIG. 8;

FIG. 9 is a sectional view taken along line 9-9 in FIG. 3 showing the retention cover arranged in the channel to engage the groove of the retention cover with the cross-member of the base;

FIG. 9A is an enlarged view of the connector of FIG. 9 showing the fasteners extending through holes of the retention cover to engage with inserts coupled to the seat;

FIG. 10 is a sectional view taken along line 10-10 in FIG. 3 showing that the seat includes a user-support portion and a seat-support portion coupled to the user-support portion to define an internal cavity of the seat between the user-support portion and seat-support portion, that the seat-support portion defines the channel and the tack-off, and that the tack-off extends from the channel toward the user-support portion to engage with the user-support portion;

FIG. 10A is an enlarged view of the tack-off of FIG. 10;

FIG. 11 is a sectional view taken along line 11-11 in FIG. 6 perpendicular to a beam of the cross-member showing the groove of the retention cover engaged with the cross-member of the base and the cross-member engaged with the channel; and

FIG. 11A is an enlarged view of FIG. 11 showing that the groove of the retention cover and the channel define a collective percentage of wrap around at least a portion of a circumference of the cross-member.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

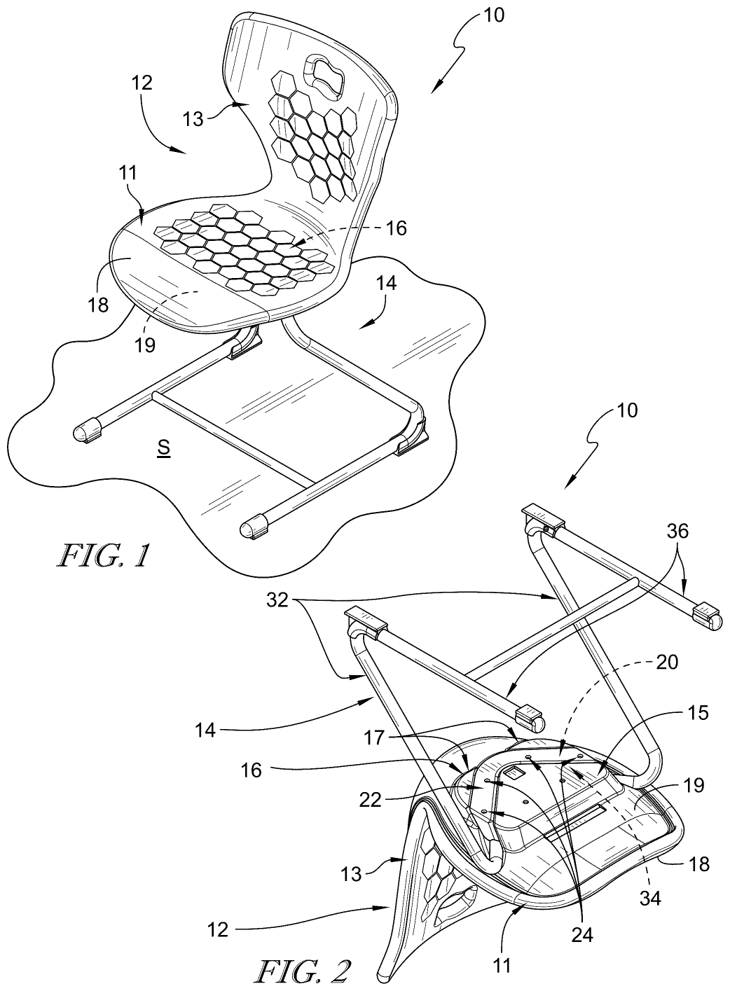

An illustrative embodiment of a chair 10 in accordance with the present disclosure is shown in FIGS. 1 and 2. The chair 10 includes a seat 12, a base 14, and a connector 16 configured to secure the seat 12 to the base 14. The connector 16 includes a channel 20 defined by the seat 12 and configured to receive a cross-member 34 of the base 14, a retention cover 22 configured to extend into the channel 20 to engage with the cross-member 34, and a plurality of fasteners 24 configured to couple the retention cover 22 with the seat 12 to hold the cross-member 34 in the channel 20 as shown in FIGS. 2-11A.

The seat 12 includes a seat pan 11, extending from a front of the chair 10 toward a rear of the chair 10, and a backrest 13, extending upward from a rear end of the seat pan 11, to support a user sitting on the chair 10 as shown in FIG. 1. In the illustrative embodiment, the seat 12 includes a user-support portion 18 and a seat-support portion 19 coupled to the user-support portion 18 that together form the seat pan 11 and backrest 13. In some embodiments, the seat 12 is formed from plastic material and shaped through a blow molding process. In some embodiments, the fasteners 24 engage with the seat-support portion 19 to hold the retention cover 22 relative to the seat 12. In some embodiments, threaded inserts 26 engage with pockets 28 in the seat 12, and the fasteners 24 engage with the threaded inserts 26 to hold the retention cover 22 relative to the seat 12. The threaded inserts 26 may provide a significantly increased length of contact with the fasteners 24 compared to engaging the fasteners 24 with the seat 12 directly (which is generally limited to the thickness of the seat-support portion 19). In some embodiments, the length of contact between the fasteners 24 and the threaded inserts 26 is at least 200% of the thickness of the seat-support portion 19. In some embodiments, the seat-support portion 19 has a thickness of 0.1 inches, and the threaded inserts 26 provide a length of contact with the fasteners 24 of 0.5 inches. In some embodiments, the threaded inserts 26 are formed from metal or another material that is stronger than the material used to form the seat-support portion 19. In some embodiments, the threaded inserts 26 have external threads for securing the threaded inserts 26 into the pockets 28 and internal threads for engaging with threads of the fasteners 24. In some embodiments, the external threads of the threaded inserts 26 are larger than the threads of the fastener 24.

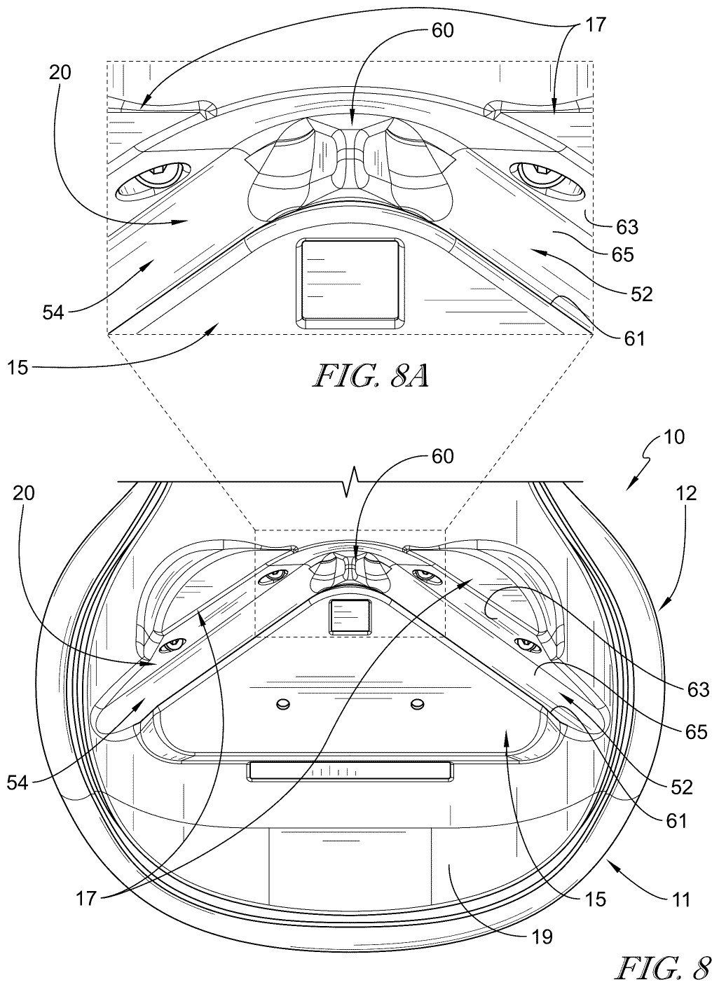

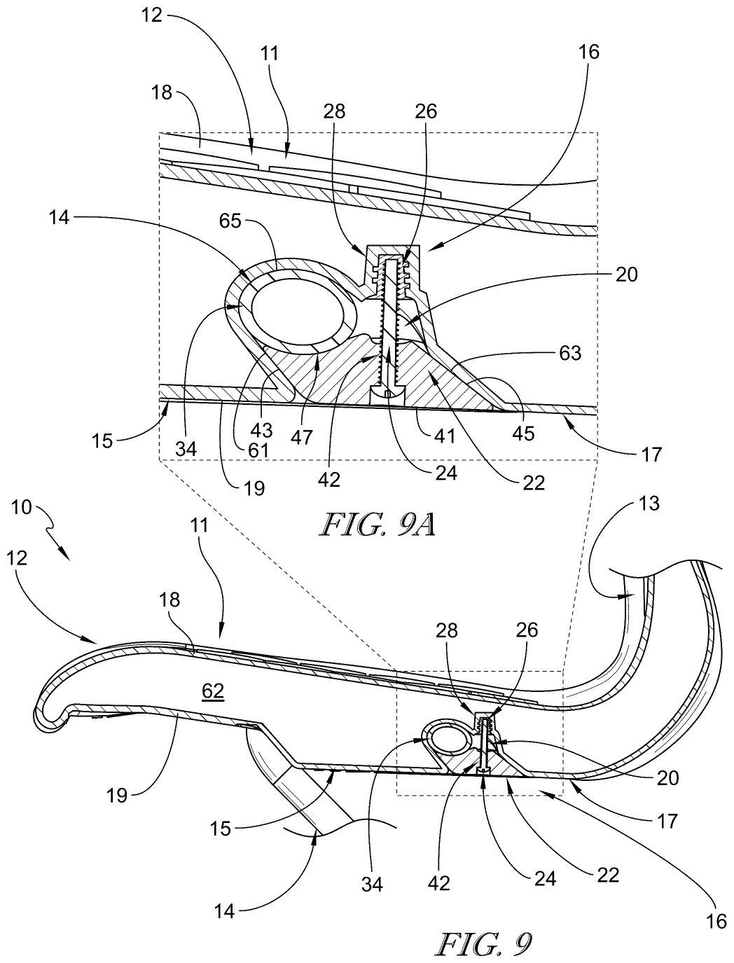

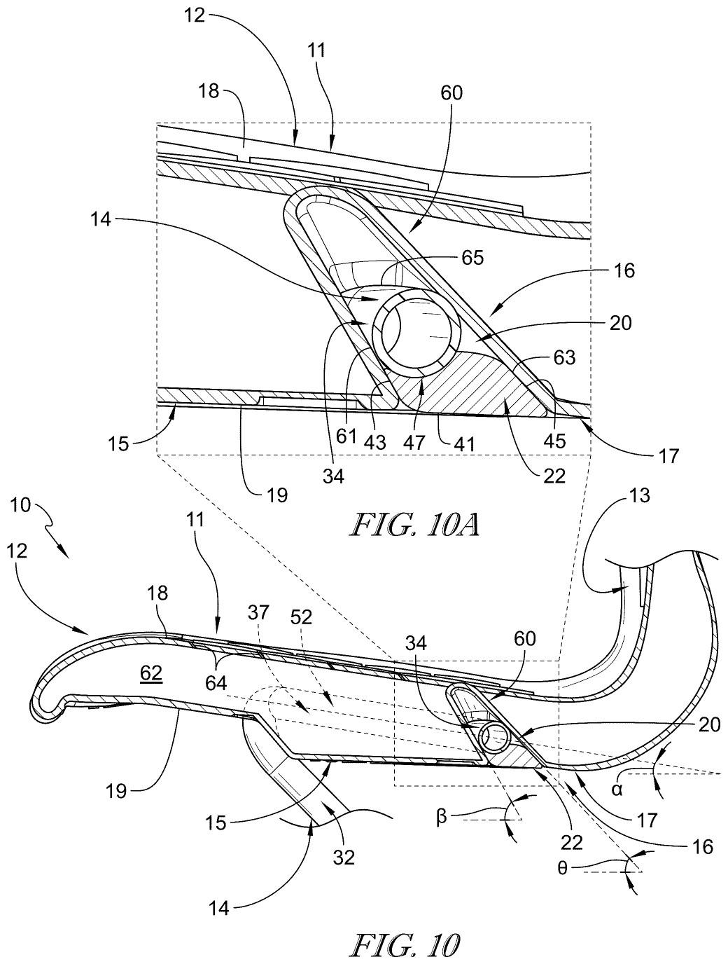

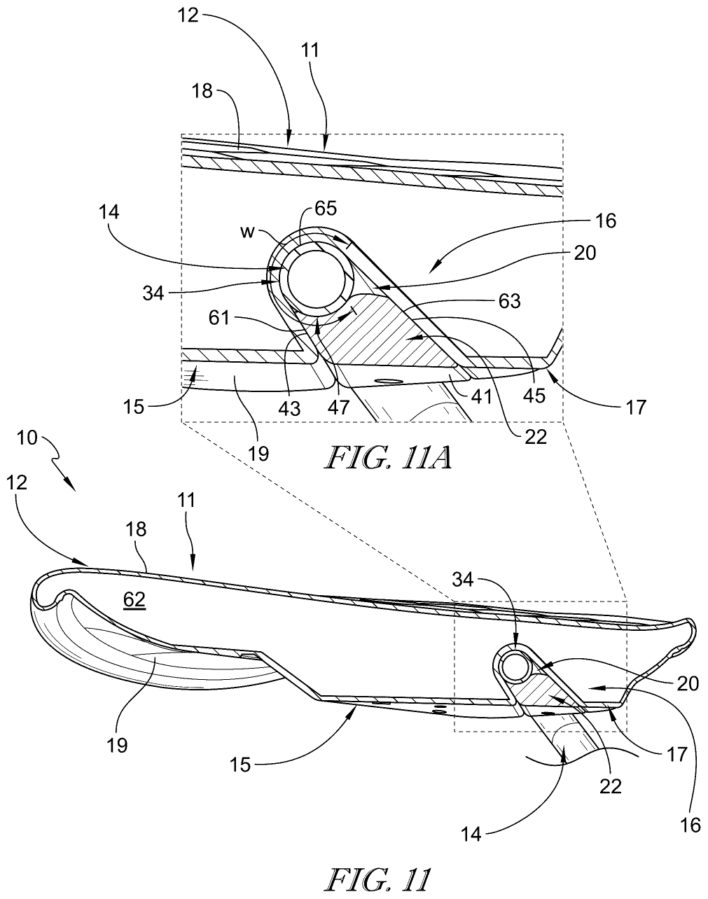

The user-support portion 18 and seat-support portion 19 are connected along a perimeter of the seat 12 and spaced apart across a remainder of the seat 12 to define an internal cavity 62 therebetween as shown in FIGS. 9-11A. In some embodiments, a tack-off 60 (sometimes called a pillar) extends from the channel 20 defined by the seat-support portion 19 toward the user-support portion 18 to engage with the user-support portion 18 and provide a reinforcement between the user-support portion 18 and seat-support portion 19 as shown in FIGS. 8, 8A, 10, and 10A. In some embodiments, ventilation holes 64 extend through the seat pan 11 and/or backrest 13 into the cavity 62 to provide air flow into and out of the cavity 62.

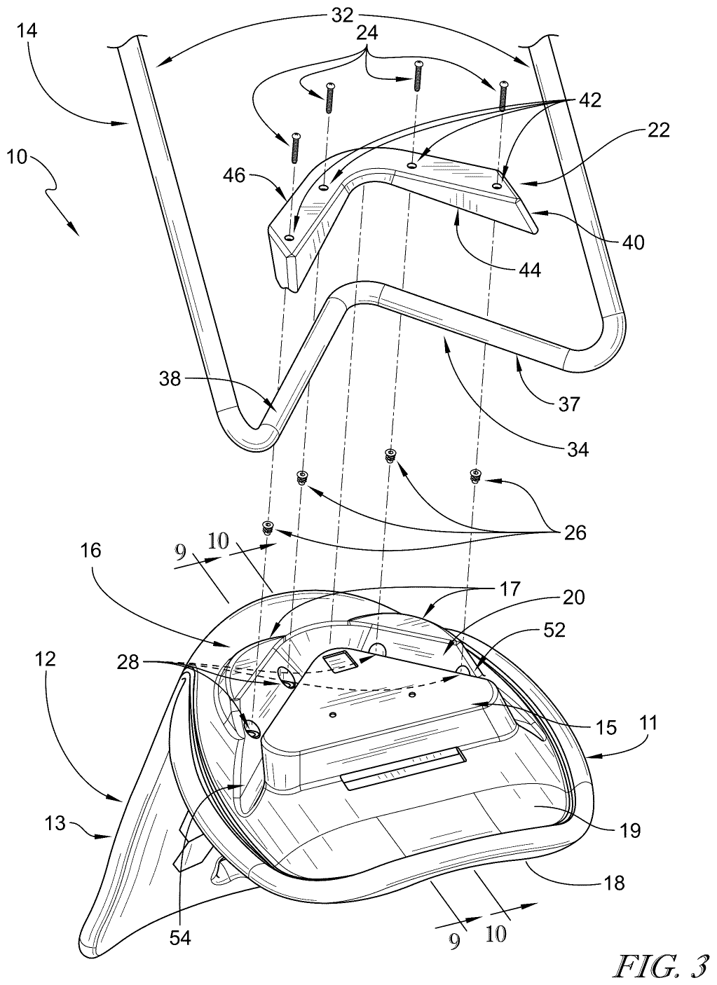

The base 14 is configured to support the seat 12 relative to a surface S beneath the chair 10 as shown in FIG. 1. In the illustrative embodiment, the base 14 includes a pair of spaced apart legs 32 and a cross-member 34 extending between the legs 32 as shown in FIGS. 2 and 3. The legs 32 define feet 36 that extend frontward from lower ends of the legs 32 (see FIG. 2). The cross-member 34 extends rearward from upper ends of the legs 32 (see FIG. 3). The legs 32 are arranged at an angle and cantilevered to the feet 36 to position the seat 12 relative to the surface S that the feet 36 are resting on.

In the illustrative embodiment, the channel 20, retention cover 22, and cross-member 34 are arranged in complementary V-shapes as shown in FIG. 3. The cross-member 34 of the base 14 includes a first beam 37 and a second beam 38 arranged at an angle relative to the first beam 37 to define a V-shape of the cross-member 34. The retention cover includes a body 40 and a plurality of holes 42 extending through the body 40 to receive the plurality of fasteners 24 of the connector 16. The body 40 defines a first arm 44 and a second arm 46 arranged at an angle relative to the first arm 44 to define a V-shape of the retention cover 22. The channel 20 includes a first section 52 and a second section 54 arranged at an angle relative to the first section 52 to define a V-shape of the channel 20. The apexes of the V-shaped channel 20, retention cover 22, and cross-member 34 points toward the rear of the chair 10. The first beam 37 of the cross-member 34 and the first arm 44 of the retention cover 22 are arranged to extend along the first section 52 of the channel 20, and the second beam 38 of the cross-member 34 and the second arm 46 of the retention cover 22 are arranged to extend along the second section 54 of the channel 20.

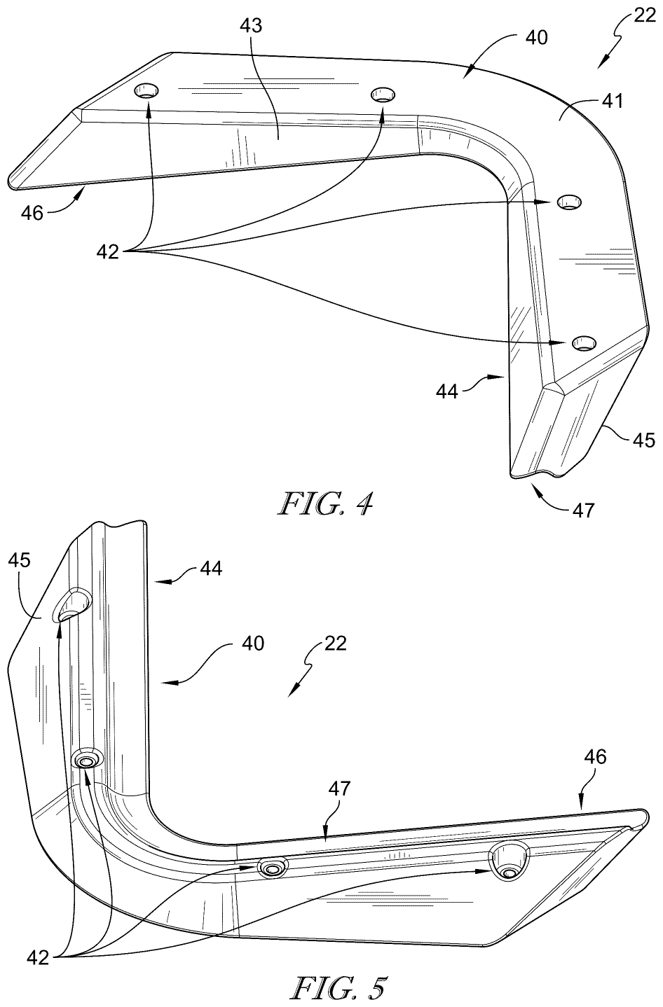

The body 40 of the retention cover 22 defines a face 41 extending along a first side of the body 40 and a groove 47 extending along an opposite second side of the body 40 as shown in FIGS. 4 and 5. The groove 47 is configured to engage with the cross-member 34 of the base 14 (see FIGS. 9A, 10A, and 11A). The retention cover 22 also defines a front wall 43 and an opposite rear wall 45. The front and rear walls 43, 45 extend between the face 41 and the groove 47. The front and rear walls 43, 45 are angled with respect to one another such that a distance between the front and rear walls 43, 45 decreases as the front and rear walls 43, 45 extend toward the groove 47. In some embodiments, the retention cover 22 is formed from a rigid material, such as metal or plastic. In some embodiments, the retention cover 22 is solid in cross-section. In some embodiments, the retention cover 22 is hollow in cross-section. In some embodiments, the retention cover 22 is formed using an injection molding or blow molding process. In some embodiments, the retention cover 22 is a single, unitary, and integral structure sized to extend along substantially an entire length of the channel 20.

The channel 20 is defined by a front surface 61 and a spaced apart rear surface 63 connected by a curved intermediate surface 65 as shown in FIGS. 8-11A. The front and rear surfaces 61, 63 are arranged at a draft angle with respect to one another such that the channel 20 is tapered with a distance between the front and rear surfaces 61, 63 decreasing as the front and rear surfaces 61, 63 extend toward the intermediate surface 65. The draft angle of the channel 20 allows for efficient manufacturing and assembly of the chair 10, and maximizes engagement between the channel 20 and cross-member 34. In the illustrative embodiment, the front wall 43 of the retention cover 22 is arranged substantially parallel to the front surface 61 of the channel 20, and the rear wall 45 of the retention cover 22 is arranged substantially parallel to the rear surface 63 of the channel 20. In some embodiments, the front and rear surfaces 61, 63 are contiguous along channel 20 as shown in FIG. 8. In some embodiments, the face 41, front and rear walls 43, 45, and groove 47 are contiguous along the body 40 of the retention cover 22 as shown in FIGS. 4 and 5. In some embodiments, the front surface 61 is arranged at an angle β relative to the surface S beneath the chair 10 in a range from about 50 degrees to about 70 degrees as shown in FIG. 10. In some embodiments, the rear surface 63 is arranged at an angle θ relative to the surface S beneath the chair 10 in a range from about 35 degrees to about 55 degrees. At least a portion of the front surface 61 of the channel 20 is arranged between the cross-member 34 of the base 14 and the surface S beneath the chair 10 along a line perpendicular to the surface S as shown in FIGS. 9-11A. At least a portion of the groove 47 and front wall 43 of the retention cover 22 is also arranged between the front surface 61 and the cross-member 34 along a line perpendicular to the surface S. The front and rear walls 43, 45 of the retention cover 22 cooperate with the front and rear surfaces 61, 63 of the channel 20, respectively, to minimize forces on the fasteners 24. For example, as forces are applied to the user-support portion 18, the front wall 43 of the retention cover 22 can engage with the front surface 61 of the channel 20 to distribute at least a portion of the forces away from the fasteners 24.

In the illustrative embodiment, the seat-support portion 19 of the seat 12 defines a front brace 15 and a pair of rear braces 17 extending away from the user-support portion 18 as shown in FIGS. 3 and 6-11A. The rear braces 17 are arranged along respective ones of the first and second sections 52, 54 of the channel 20 opposite of the channel 20 from the front brace 15. In some embodiments, the front brace 15 defines at least a portion of the front surface 61 of the channel 20, and the rear braces 17 define at least a portion of the rear surface 63 of the channel 20. In some embodiments, the front and rear braces 15, 17 are arranged substantially parallel to the surface S beneath the chair 10 and substantially co-planar to one another. In some embodiments, the face 41 of the retention cover 22 is substantially co-planar with the front and rear braces 15, 17 when arranged in the channel 20.

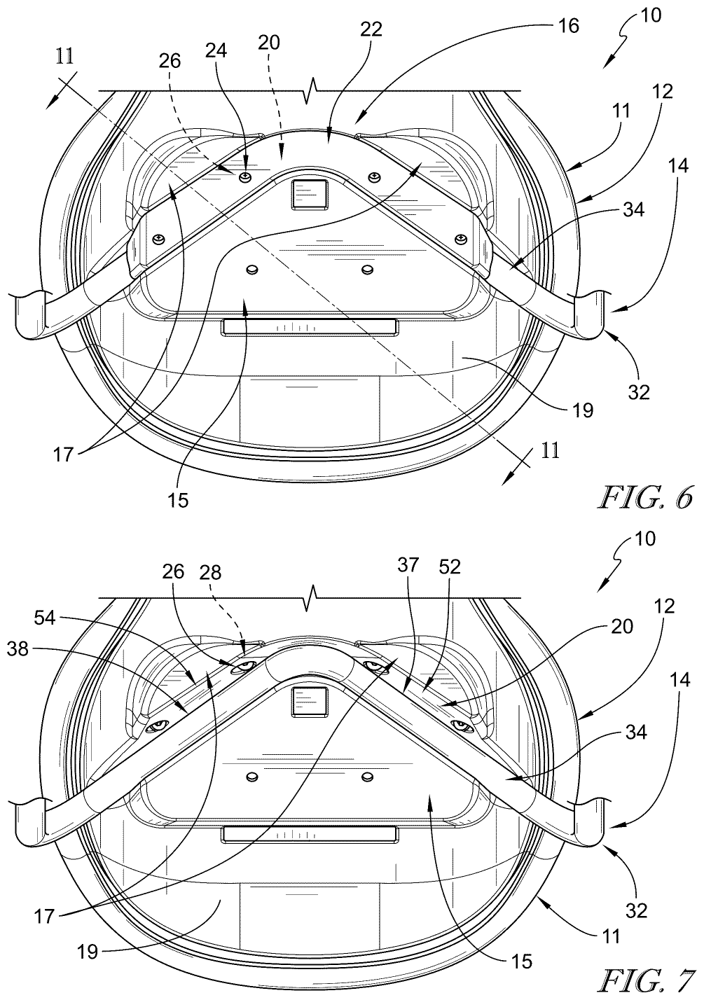

In an exemplary process for assembling the chair 10, the threaded inserts 26 are secured in the pockets 28 defined in the seat-support portion 19 as shown in FIGS. 3, 9, and 9A. The cross-member 34 of the of the base 14 extends into the channel 20 (compare FIG. 8 with FIG. 7) and is arranged in contact with the intermediate surface 65 as shown in FIGS. 9-11A. The retention cover 22 extends into the channel 20 (compare FIG. 7 with FIG. 6) and is arranged with the groove 47 in contact with cross-member 34 of the base 14. The fasteners 24 extend through the holes 42 in the retention cover 22 to engage with the threaded inserts 26 to couple the retention cover 22 with the seat 12 and hold the cross-member 34 in the channel 20 as shown in FIGS. 3, 9, and 9A. In the illustrative embodiment, the fasteners 24 are rearward of the cross-member 34. While four fasteners 24 and four inserts 26 are shown, more or less fasteners 24 and/or inserts 26 may be used.

In the illustrative embodiment, the channel 20 and the cross-member 34 of the base 14 are arranged at an angle α relative to the surface S beneath the chair 10 such that the channel 20 and the cross-member 34 are positioned closer to the surface S as the channel 20 and the cross-member 34 extend in a direction from the front of the chair 10 toward the rear of the chair 10 as shown in FIG. 10. The angle α biases the seat 12 rearward relative to the base 14 when a user sits on the chair 10 to bias the cross-member 34 into the channel 20 toward the front of the chair 10 in order to minimize forces tending to bias the cross-member 34 away from the channel 20. In some embodiments, the angle α is in a range from about 5 degrees to about 15 degrees. In some embodiments, a distance between the face 41 of the retention cover 22 and the groove 47 increases as the retention cover 22 extends in a direction from the rear of the chair 10 toward the front of the chair 10 as shown in FIGS. 3-5.

As shown in FIGS. 8, 8A, 10, and 10A, the exemplary tack-off 60 extends from the channel 20 into the seat 12 toward the user-support portion 18 to engage with the user-support portion 18 and provide a reinforcement between the user-support portion 18 and seat-support portion 19. In the illustrative embodiment, the tack-off 60 is positioned between the first and second sections 52, 54 of the channel 20 at the apex of the V-shape and arranged to transmit forces on the user-support portion 18 from a user sitting on the chair 10 to the cross-member 34 of the base 14. Arranging the tack-off 60 along a centerline of the chair 10 assists in distributing forces more evenly across the chair 10 and minimize bending forces on the user-support portion 18. In some embodiments, the tack-off 60 is arranged in another location, such as forward or rearward of the channel 20. In some embodiments, multiple tack-offs 60 may be distributed along the channel 20. In some embodiments, the tack-off 60 is arranged in a substantially frustopyrimidal shape that includes front and rear portions substantially parallel to the front and rear surfaces 61, 63 of the channel 20 (see FIG. 10). The tack-off 60 may assume different shapes in some embodiments, such as frustoconical, cylindrical, square, or triangular, among other geometric and non-geometric shapes. In some embodiments, the tack-off 60 can be larger or smaller (e.g., extending a greater or lesser distance along the first and second sections 52, 54 of the channel 20). The tack-off 60 is arranged at an angle relative to the surface S beneath the chair 10 based at least in part on the angles β, θ of the front and rear surfaces 61, 63, respectively, such that the tack-off 60 extends further away from the surface S as the tack-off 60 extends in a direction from the rear of the chair 10 toward the front of the chair 10 in order to provide resistive forces from the cross-member 34 to the user-support portion 18 in a direction based at least in part on the angle α of the channel 20 and cross-member 34 in order to balance relative forces between the base 14 and the seat 12 when a user sits in the chair 10. In some embodiments, an upper end of the tack-off 60 is secured to the user-support portion 18 (sometimes called an I-beam construction), such as by fusing a portion of the tack-off 60 with a portion of the user-support portion 18 during a blow molding process. In some embodiments, an upper end of the tack-off 60 is spaced apart from the user-support portion 18, but engages with the user-support portion 18 when a user sits in the chair 10.

As shown in FIGS. 11 and 11A (sectional views cutting across the chair 10 perpendicular to one of the beams 37, 38 of the cross-member 34), the groove 47 of the retention cover 22 contacts the cross-member 34 along a portion of a circumference of the cross-member 34 and one or more of the surfaces 61, 63, 65 of the channel 20 contact the cross-member 34 along other portions of the circumference of the cross-member 34 to collectively define a percentage of wrap W around the cross-member 34. The groove 47 of the retention cover 22 and surfaces 61, 63, 65 of the channel 20 contact the cross-member 34 along at least a portion of a length of the cross-member 34 between the legs 32 and, together with the percentage of wrap W, defines a contact area between the cross-member 34 and the connector 16. In the illustrative embodiment, the percentage of wrap W is not consistent across the length of the cross-member 34 due to gaps in the surfaces 61, 63, 65 of the channel 20, such as for the pockets 28 and tack-off 60. In some embodiments, the percentage of wrap W is consistent across a majority of the length of the cross-member 34. In some embodiments, the contact area includes a percentage of wrap W of 50% to 95% of the circumference of the cross-member 34 for 30% to 50% of the length of the cross-member 34. In some embodiments, the contact area includes a percentage of wrap W of 75% to 95% of the circumference of the cross-member 34 for 40% to 50% of the length of the cross-member 34.

The embodiment(s) detailed hereinabove may be combined in full or in part, with any alternative embodiment(s) described.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

While the present disclosure describes various exemplary embodiments, the disclosure is not so limited. To the contrary, the disclosure is intended to cover various modifications, uses, adaptations, and equivalent arrangements based on the principles disclosed. Further, this disclosure is intended to cover such departures from the present disclosure as come within at least the known or customary practice within the art to which it pertains. It is envisioned that those skilled in the art may devise various modifications and equivalent structures and functions without departing from the spirit and scope of the disclosure as recited in the following claims.

1. A chair comprising:
a seat adapted to support a user sitting on the chair;
a base adapted to support the seat relative to a surface beneath the chair; and
a connector configured to secure the seat to the base, the connector comprising:
a channel defined by the seat and configured to receive a cross-member of the base;
a retention cover configured to extend into the channel to engage with the cross-member;
a plurality of threaded inserts coupled to the seat; and
a plurality of fasteners configured to engage with the threaded inserts to couple the retention cover with the seat to hold the cross-member in the channel.

2. The chair of claim 1, wherein retention cover includes a body and a plurality of holes extending through the body to receive the plurality of fasteners.

3. The chair of claim 2, wherein the seat includes a user-support portion and a seat-support portion coupled to the user-support portion to define an internal cavity of the seat between the user-support portion and seat-support portion, wherein the fasteners extend through the holes in the retention cover to engage with the threaded inserts to hold the retention cover relative to the seat-support portion, and wherein a length of contact between the fasteners and the threaded inserts is at least 200% of a thickness of the seat-support portion.

4. The chair of claim 2, wherein channel includes a first section and a second section arranged at an angle relative to the first section to define a V-shape of the channel, wherein the body of the retention cover defines a first arm and a second arm arranged at an angle relative to the first arm to define a V-shape of the retention cover, and wherein the cross-member of the base includes a first beam and a second beam arranged at an angle relative to the first beam to define a V-shape of the cross-member.

5. The chair of claim 4, wherein the body of the retention cover defines a face extending along a first side of the body and a groove extending along an opposite second side of the body, and wherein the groove is configured to engage with the cross-member of the base.

6. The chair of claim 5, wherein the channel and the cross-member are arranged at an angle relative to the surface beneath the chair such that the channel and the cross-member are positioned closer to the surface as the channel and the cross-member extend in a direction from a front of the chair toward a rear of the chair, and wherein a distance between the face and the groove of the retention cover increases as the retention cover extends in a direction from the rear of the chair toward the front of the chair.

7. The chair of claim 6, wherein the seat includes a user-support portion and a seat-support portion coupled to the user-support portion to define an internal cavity of the seat between the user-support portion and seat-support portion, wherein the seat-support portion defines the channel and a tack-off extending into the seat from the channel toward the user-support portion to engage with the user-support portion.

8. The chair of claim 7, wherein an upper end of the tack-off is secured to the user-support portion.

9. The chair of claim 7, wherein the tack-off is arranged at an angle relative to the surface beneath the chair such that the tack-off extends further away from the surface beneath the chair as the tack-off extends in a direction from a rear of the chair toward a front of the chair.

10. The chair of claim 5, wherein the channel is defined by a front surface and a spaced apart rear surface connected by a curved intermediate surface, wherein the front and rear surfaces are angled with respect to one another such that a distance between the front and rear surfaces decreases as the front and rear surfaces extend toward the intermediate surface.

11. The chair of claim 10, wherein the retention cover defines a front wall and an opposite rear wall, wherein the front and rear walls extend between the face and the groove, and wherein the front and rear walls are angled with respect to one another such that a distance between the front and rear walls decreases as the front and rear walls extend toward the groove.

12. The chair of claim 11, wherein the front wall of the retention cover is substantially parallel to the front surface of the channel, and wherein the rear wall of the retention cover is substantially parallel to the rear surface of the channel.

13. The chair of claim 12, wherein at least a portion of the front surface of the channel is arranged between the cross-member of the base and the surface beneath the chair along a line perpendicular to the surface beneath the chair, and wherein at least a portion of the groove and front wall of the retention cover is arranged between the front surface of the channel and the cross-member along the line perpendicular to the surface.

14. The chair of claim 10, wherein the base includes a pair of spaced apart legs defining feet at lower ends of the legs and the cross-member extending between the legs.

15. The chair of claim 14, wherein the feet extend frontward from the lower ends of the legs, and wherein the cross-member extends rearward from upper ends of the legs.

16. The chair of claim 14, wherein the groove of the retention cover contacts the cross-member along a portion of a circumference of the cross-member and one or more of the front surface, rear surface, and intermediate surface of the channel contacts the cross-member along other portions of the circumference of the cross-member to collectively define a percentage of wrap around the cross-member along at least a portion of a length of the cross-member between the legs to define a contact area between the cross-member and the connector.

17. The chair of claim 16, wherein the contact area includes a percentage of wrap of 50% to 95% of the circumference of the cross-member for 30% to 50% of the length of the cross-member.

18. A chair comprising:
a seat adapted to support a user sitting on the chair, the seat including a user-support portion and a seat-support portion coupled to the user-support portion to define an internal cavity of the seat between the user-support portion and seat-support portion;
a base adapted to support the seat relative to a surface beneath the chair, the base including a pair of spaced apart legs defining feet at lower ends of the legs and a cross-member extending between upper ends of the legs, the cross-member of the base including a first beam and a second beam arranged at an angle relative to the first beam to define a V-shape of the cross-member;
a connector configured to secure the seat to the base, the connector comprising:
a channel defined by the seat-support portion and configured to receive the cross-member of the base, the channel including a first section and a second section arranged at an angle relative to the first section to define a V-shape of the channel;
a retention cover including a body and a plurality of holes extending through the body, the body of the retention cover defining a first arm and a second arm arranged at an angle relative to the first arm to define a V-shape of the retention cover, the retention cover configured to extend into the channel to engage with the cross-member; and
a plurality of fasteners configured to extend through the holes of the retention cover to couple the retention cover with the seat to hold the cross-member in the channel; and
a tack-off extending into the seat from the channel toward the user-support portion to engage with the user-support portion.

19. The chair of claim 18, further comprising a plurality of threaded inserts coupled to the seat-support portion of the seat, and wherein the fasteners extend through the holes in the retention cover to engage with the threaded inserts to hold the retention cover relative to the seat.

20. A chair comprising:
a seat adapted to support a user sitting on the chair;
a base adapted to support the seat relative to a surface beneath the chair; and
a connector configured to secure the seat to the base, the connector comprising:
a channel defined by the seat and configured to receive a cross-member of the base, the channel defined by a front surface and a spaced apart rear surface connected by a curved intermediate surface;
a retention cover configured to extend into the channel to engage with the cross-member, the retention cover defining a face extending along a first side of the body, a groove extending along an opposite second side of the body configured to engage with the cross-member of the base, a front wall and an opposite rear wall, the front and rear walls extend between the face and the groove; and
a plurality of fasteners configured to couple the retention cover with the seat to hold the cross-member in the channel,
wherein at least a portion of the front surface of the channel is arranged between the cross-member of the base and the surface beneath the chair along a line perpendicular to the surface beneath the chair, and wherein at least a portion of the groove and front wall of the retention cover is arranged between the front surface of the channel and the cross-member along the line perpendicular to the surface.
